(19) United States
(12) Patent Application Publication
(10) Pub. No.: US 2010/0207726 A1
(43) Pub. Date: Aug. 19, 2010

(54) Electronic Entity Capable of Communicating With a Reader and Method Used Within Such an Electronic Entity

(75) Inventors: Sylvestre DENIS, Ville Houilles (FR); Gerald GALAN, Ville D'Avray (FR)

Correspondence Address: YOUNG & THOMPSON, 209 Madison Street, Suite 500, Alexandria, VA, 22314, US

(73) Assignee: OBERTHUR TECHNOLOGIES, Levallois-Perret (FR)

(21) Appl. No.: 12/704,606

(22) Filed: Feb. 12, 2010

(30) Foreign Application Priority Data
Feb. 11, 2009 (FR) 0950859

(51) Int. Cl. G06F 7/04; G06K 7/01

(52) U.S. Cl. 340/5.74; 340/10.1

(57) ABSTRACT

An electronic entity includes a processing circuit (210) capable of receiving a request from a reader and a position sensor (230) capable of measuring an orientation of the electronic entity and of delivering to the processing circuit (210) an item of information indicative of the measured orientation. The processing circuit (210) automatically transmits data to the reader in response to the request provided that the information indicates that the electronic entity is in an orientation included in a predetermined set of orientations.

The invention relates to an electronic entity capable of communicating with a reader and a method used in such an electronic entity.

It is known practice to exchange data between an electronic entity and a reader via contactless communication means. It is therefore frequently envisaged in this case that the electronic entity (for example a chip card fitted with short-range contactless communication means) should automatically transmit certain data that it contains in response to an appropriate request from the reader.

There is then however the problem already exposed for example in patent application FR 2 888 976 that such data could be transmitted unintentionally and/or without the knowledge of the holder of the electronic entity, which may be prejudicial, for example when the data concerned are confidential.

For the purpose of providing a simple and practical solution to this problem, the invention proposes an electronic entity characterized in that it comprises processing means capable of receiving a request from a reader and a position sensor capable of measuring an orientation of the electronic entity and of delivering to the processing means an item of information indicative of the measured orientation, the processing means being capable of automatically transmitting data to the reader in response to the request provided that the information indicates that the electronic entity is in an orientation included in a predetermined set of orientations.

The user can therefore control the transmission of data by the electronic entity by changing the position of the latter.

The use of such a sensor in an electronic entity is for example described in document US 2008/091 605 but does not address the technical problem mentioned above.

The processing means comprise for example means for contactless communication with the reader; these communication means can therefore receive the request and transmit the data.

These communication means can in particular be remotely powered by the reader. These are then for example passive communication means in the absence of remote powering but activated when they are brought close to the reader. The technical problem exposed above exists in particular in this context.

The communication means are for example capable of executing a short-range communication with the reader, as according to the NFC or ISO14443 standard as explained below.

The aforementioned condition for the transmission of the data is for example applied by virtue of means for preventing an exchange of information between the electronic entity and the reader if the information indicates that the electronic entity is in an orientation not included in said set.

The means for preventing the exchange can in practice deactivate a module for communication with the reader. The means for preventing the exchange can also inhibit the execution of an application causing the exchange of the data when it is executed by a processor of the electronic entity. This situation prevents having to modify the application itself, which is of particular value when the latter requires certification and therefore cannot be easily modified. In this case, provision can be made that, when the reader calls the application, it receives in response an error message indicating that the application (inhibited) is not present or not available.

The means for preventing the exchange can also be designed to terminate a communication between the entity and the reader without executing data-exchange instructions.

The means for preventing can also, as a variant, inhibit only the communication to the reader of certain data.

When the electronic entity (for example a cell phone) comprises a chip card (typically for identification with a mobile telephone network), the chip card may comprise the position sensor. This makes it possible to use the present solution by fitting the electronic entity with such a card, without the other portions of the electronic entity being designed for this purpose. It is possible to provide, in this case, means for configuring the position of the card in the electronic entity.

The processing means can, in particular in this latter context, be included in a card of a subscriber to a mobile telephone network complying with the ISO7816 standard.

It is however possible as a variant to provide that the position sensor (like the short-range communication means) is included in the telephone itself (that is to say outside the card).

The measured orientation is for example an angular value relative to the vertical, defined by Earth's gravity.

In the example described below, the electronic entity is a cell phone fitted with a chip card. Other electronic entities may of course be involved, such as an electronic passport, a chip card taken in isolation (for example complying with the ISO7816 standard or of the memory card type), or a portable memory fitted with a connector (such as a USB key).

Therefore the invention also proposes a method used by processing means of an electronic entity comprising a position sensor, characterized in that it comprises the following steps:
reception of a request from a reader;
reception of an item of information indicative of the orientation of the electronic entity measured by the sensor;
automatic transmission of data to the reader in response to the request provided that the item of information indicates that the electronic entity is in an orientation included in a predetermined set of orientations.

The optional features mentioned above for the electronic entity can optionally also apply to this method.

Other features and advantages of the invention will appear more clearly in the light of the following description, made with reference to the appended drawings in which:

FIG. 1 represents an electronic entity (in this instance a cell phone) according to the disclosures of the invention;

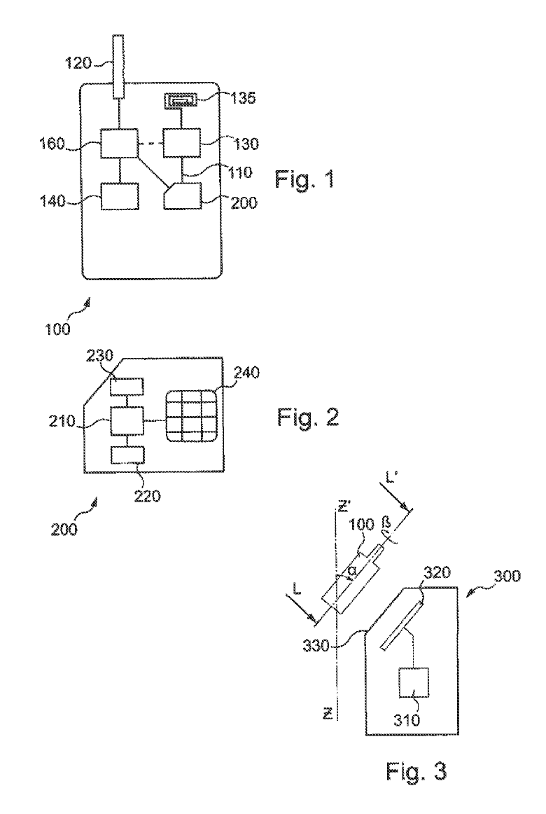

FIG. 2 represents in detail a chip card fitted to the electronic entity of FIG. 1;

FIG. 3 represents the electronic entity of FIG. 1 during its interaction with a reader;

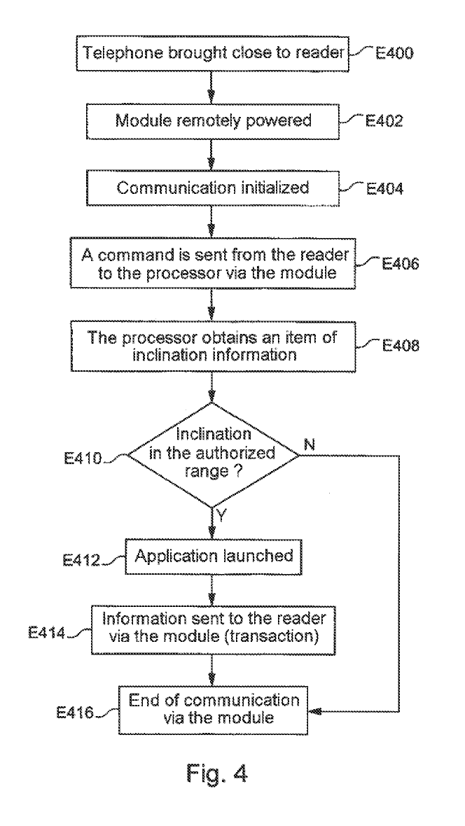

FIG. 4 represents a first example of a method according to the disclosures of the invention;

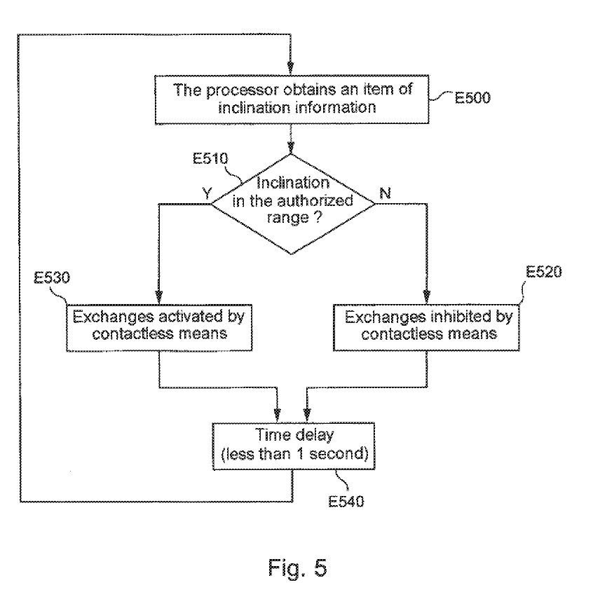

FIG. 5 represents a second example of a method according to the disclosures of the invention.

FIG. 1 represents a cell phone which comprises a processor 160 and telecommunication means (particularly an antenna) 120 so that the processor 160 is capable of exchanging data (which may in particular represent a voice signal) with a telecommunication, typically telephony, cellular network.

The cell phone 100 carries (in a housing provided for this purpose and having contacts) a removable card for identification with the telephony network, in the form of a chip card described in greater detail below with reference to FIG. 2. This card is for example of the SIM (for “Subscriber Identity Module”), USIM (for “Universal Subscriber Identity Module”) or RUIM (for “Removable Universal Identity Module”) type.

The card 200 (specifically its processor 210 as described below) is in communication with the processor 160 of the telephone 100 by means of contacts 240 of the card (also described below) which interact with the previously mentioned contacts of the housing.

The telephone 100 also comprises contactless communication means formed in this instance by a contactless module 130 and an antenna 135.

The contactless module 130 is in this instance in direct communication with the card 200, for example via an SWP (for “Single Wire Protocol”) link and the contactless module 130 can therefore also exchange data with the processor 210 of the card 200.

As a variant, it would be possible to provide that the contactless module 130 is in communication with the processor 160 of the telephone 100 (as shown in dashed line in FIG. 1) and the exchange of data and/or of instructions between the contactless module 130 and the card 200 (specifically its processor 210) could take place via the processor 160.

The contactless module 130 and the antenna 135 in this instance form short-range contactless communication means, for example according to the NFC (for “Near Field Communication”) standard, with a range usually of less than 20 cm, and typically less than 10 cm.

Such communication means can also comply with the ISO14443 standard.

According to a possible variant, the contactless communication means are medium-range communication means (that is to say with a range of less than 20 m), for example of the Bluetooth® type.

The cell phone 100 also comprises a nonvolatile memory 140 associated with the processor 160.

FIG. 2 represents in greater detail the card 200 already mentioned.

As already indicated, this card comprises contacts 240 connected to the processor 210 (typically a microprocessor) of the card 200. The card 200 also comprises an inclination sensor 230 capable of determining the orientation of the card 200 (and therefore of the cell phone 100 because the physical relationship between these two elements is fixed since the card 200 is accommodated in the housing of the telephone 100 as already indicated) relative to the vertical (defined by the field of Earth's gravity). The inclination sensor 230 is for example an inclinometer or a gyroscope-based system, typically made in the form of MEMS (for “Micro Electro Mechanical System”).

The inclination sensor 230 is connected to the processor 210 in order to exchange data with the latter, particularly information indicative of the measured inclination.

The card 200 also comprises a nonvolatile memory 220 which stores in particular at least one range of orientation values corresponding to authorized positions and a contactless communication application (hereinafter called “contactless application”), these elements and their role in the operation of the cell phone and of the card being described in greater detail below. Several ranges or sets of orientation values authorizing an exchange of data can be stored in the nonvolatile memory 220 (each set optionally being associated with one or more applications), for example in the form of an orientations library.

Note that the connections between elements are represented in the figures by a single line for the purposes of simplification, even when in reality several wires (typically a bus) are used to electrically connect the two elements concerned (this being valid in FIG. 1 as in FIG. 2).

The assembly formed by the cell phone 100 and the card 200 has, as already indicated, contactless communication means 130, 135, in this instance carried by the telephone 100. According to a conceivable variant, the card 200 could comprise, in addition to or in place of these contactless communication means 130, 135 carried by the telephone, similar contactless communication means (formed, for example, also by a contactless module and an antenna). In this case, the microprocessor 210 of the card 200 could exchange data through the short-range contactless link through these communication means included in the card instead of doing so through the communication means 130, 135 of the telephone 100 as will be described below.

FIG. 3 schematically represents a reader 300 comprising an electronic module 310 and an antenna 320 so that the electronic module 310 is capable of entering into communication with the microprocessor 210 of the card 200 through the contactless communication means 130, 135 when the assembly formed by the telephone 100 and the card 200 are sufficiently close to the antenna 320 of the reader 300, for example at a distance of less than 10 cm as already indicated.

Provision is also made that, according to modalities explained below, the data exchange is used only when the cell phone 100 is in a determined orientation (as measured by the inclination sensor 230).

If the longitudinal direction of extension of the telephone 100 is designated LL′ and the vertical at the point in question is designated ZZ′, the data will not be exchanged between the telephone 100 (in this instance the microprocessor 210 of the card 200, but as a variant possibly the processor 160) and the reader 300 unless the angle α between the directions ZZ' and LL′ is equal to 45° with a tolerance (for example of)25°, that is to say if the angle as determined by the inclination sensor 230 is between 20° and 70°.

In order to encourage the user to place his cell phone 100 in this way, it is possible to provide that the reader 300 has an inclined face 330 with an inclination equal to that required for the exchange of the data as just described.

It is also possible to provide that the orientation sensor 230 is capable of determining the position (angle β) of the card 200 and therefore of the cell phone 100, about its longitudinal axis LL′ and of authorizing the data exchange only when the angle β is in a determined range (which corresponds for example to a position of the cell phone with the screen turned upward, also with a tolerance).

FIG. 4 represents the main steps of a method used according to the disclosures of the invention.

This method begins at step E400 with the telephone 100 and the reader 300 (in particular the antenna 330 of this reader) being brought closer together (by the action of the user).

This bringing closer causes the contactless module 130 to be remotely powered (step E402).

A communication is thus initialized at step E404 between the module 310 of the reader 300 and the contactless module 130, which notably allows the transmission of a command (or request) from the module 310 of the reader 300 to the processor 210 of the card 200, via the contactless module 130 and the SWP type connection 110 (step E406). The object of this command is the launching within the processor 210 of the contactless application stored as already indicated in the nonvolatile memory 220 in order to execute an exchange of information between the processor 210 and the module 310 of the reader 300 according to a determined protocol, for example representing a financial transaction.

According to the variant already mentioned in which the data are exchanged between the contactless module 130 and the processor 210 of the card 200 via the processor 160 of the cell phone 100, the aforementioned command transmitted by the reader will pass through the processor 160 and will be transmitted from the latter to the processor 210 for example in the form of a command according to the ISO7816 standard, for example a command to select an application.

Whatever the case, the method continues at step E408 at which the processor 210 interrogates the inclination sensor 230 in order to obtain an item of inclination information (step E408).

The processor 210 then compares the inclination information obtained from the sensor 230 with the range of authorized values stored in the nonvolatile memory 220 in order to determine whether the actual orientation of the telephone 100 (and therefore of the card 200) is included in the orientations in which a transaction between the processor 210 and the reader 300 is authorized (as explained above with reference to FIG. 3).

If it is, the method continues in step E412 to the launching of the application, which will have the particular consequence of sending information from the processor 210 to the reader 300 (specifically its module 310) through the contactless module 130 in order to carry out the aforementioned financial transaction.

According to a conceivable variant, the application can be launched in all cases (that is to say irrespective of the measured orientation), but the transmitted data (at the command of the application) will not be the expected data (for example stored in the nonvolatile memory 220) unless the measured orientation is included in the orientations in which a transaction is authorized; if the measured orientation is not included in these authorized orientations, the application will not transmit the expected data but an error message (or random or errored data, such as a sequence of zeros). Provision can naturally be made in this context for certain data (not critical to security) to be sent irrespective of the measured orientation while the communication of other data is inhibited when the measured orientation is not included in the authorized orientations.

The transaction authorized by the determined orientation of the cell phone 100 (in practice by the positive verification of step E410) can naturally include information exchanges other than the transmission of information that has just been described as an example.

Once the transaction is completed, in step E416 the contactless communication between the module 130 and the reader 300 is terminated.

In the negative in step E410, the communication is terminated directly in step E416 as shown in FIG. 4.

The execution of the transaction (for example a financial transaction) is therefore authorized only when the processor 210 determines, with the aid of the information received from the sensor 230, that the orientation of the telephone 100 is in a predetermined range corresponding to an authorization to carry out the transaction.

In the example that has just been described, the verification of the inclination is carried out by the processor 210 before execution of the contactless application (that is to say by the execution of another application, for example of the operating system of the card 200). As a variant, provision could be made for the comparison of the inclination determined by the sensor with the stored values to be carried out by the contactless application itself.

FIG. 5 represents certain steps of a method according to a second exemplary embodiment of the invention.

According to this embodiment, the processor periodically obtains (by interrogating the inclination sensor 230) an item of inclination information representing the orientation of the cell phone 100 (step E500).

The processor 210 then determines whether the inclination is in an authorized range (according to the values defining the authorized range stored in the nonvolatile memory 220).

If the inclination is not in an authorized range, the method proceeds in step E520 to the inhibition of the exchanges through the contactless means 130, 135.

According to a first possible embodiment, this inhibition is carried out by the processor 210 sending a deactivation command to the contactless module 130 so that the latter allows no exchange of information, even if the telephone 100 (and consequently the antenna 135) is brought closer to the antenna 320 of the reader 300.

According to a second possible embodiment, the inhibition of the exchanges can be carried out in a software manner, for example by the writing in a memory (such as the nonvolatile memory 220) of an item of information inhibiting the launching of the contactless application stored in nonvolatile memory 220; this inhibition information is for example a flag formed by a bit dedicated to that purpose. As a variant, it is possible to carry out the inhibition by erasing (that is to say by writing a value that is for example zero) a pointer indicating the storage address in the nonvolatile memory 220 of the contactless application.

According to a conceivable variant, provision may be made to inhibit not the application itself but the transmission via the contactless interface of certain data obtained from the data stored in the nonvolatile memory 220 (such an inhibition being carried out in a software manner). It is possible in this context to use a table, stored for example in nonvolatile memory, which indicates, for each datum (or data type), the orientations in which a transmission of the data concerned is authorized.

If, on the contrary, it is determined that the inclination measured by the sensor 230 is in the authorized range stored in nonvolatile memory 220 in step E510, the method proceeds in step E530 to the activation of the exchanges by the contactless means.

According to the first possible embodiment described above, this activation is carried out by the microprocessor 210 sending an activation command to the contactless module 130.

According to the second possible embodiment, the activation is carried out by writing an item of authorization information in a memory associated with the microprocessor 210, for example by setting the aforementioned flag to a value corresponding to this authorization or by writing the address of the contactless application in the aforementioned pointer.

Note that the two envisaged possibilities can be combined.

Whether the exchanges are activated (step E530) or inhibited (step E520), the method proceeds to a time delay (typically of less than one second) in step E540 before again executing step E500. As already indicated, the step E500 is thus applied periodically with a periodicity for example of between 2 and 50 times per second.

It is understood that, by virtue of the method that has just been described, bringing the telephone 100 closer to the reader 300 will have the effect of executing a contactless communication via the communication means 130, 135 and the launching of the contactless application only if these various elements are activated, that is to say when it has been determined in step E510 that the inclination of the cell phone is in a range corresponding to the authorization given by the user (or by the device) to exchange data with the reader 300.

Note that, in the examples that have just been described, the movement or the position of the cell phone 100 is deduced from the movements or the position of the chip card 200 because these two elements are physically linked.

It may therefore be desirable to configure the positioning of the chip card 200 in the cell phone 100. It is a configuration step which can naturally be carried out only during the first insertion of the chip card 200 into the cell phone 100.

According to a first possible embodiment, the positioning of the card 200 in the cell phone 100 can be indicated by the user with the aid of the telephone keypad in response to the display of a corresponding menu (stored in the chip card) by means of the telephone screen.

According to a second possible embodiment, an application executed by the processor 210 causes the display, on the screen, of a message prompting the user to position the cell phone 100 successively in several particular orientations.

The detection by the sensor 230 situated in the card 200 of the successive orientations of the telephone 100 which is carried out by the user then allows the processor 210 to deduce the relative orientation of the chip card 200 and of the cell phone 100.

The foregoing embodiments are only possible examples of applying the invention which is not restricted thereto.

1. Electronic entity characterized in that it comprises:
processing means (135, 130, 210) capable of receiving a request from a reader (300);
a position sensor (230) capable of measuring an orientation (α) of the electronic entity (100, 200) and of delivering to the processing means (135, 130, 210) an item of information indicative of the measured orientation (α),
the processing means (135, 130, 210) being capable of automatically transmitting data to the reader (300) in response to the request provided that the information indicates that the electronic entity is in an orientation (α) included in a predetermined set of orientations.

2. Electronic entity according to claim 1, characterized in that the processing means comprise means (135, 130) for a contactless communication with the reader (300) that are capable of receiving the request and of transmitting the data.

3. Electronic entity according to claim 2, characterized in that the communication means (135, 130) are capable of executing a short-range communication with the reader.

4. Electronic entity according to claim 1, characterized by means for preventing an exchange of information between the electronic entity (100, 200) and the reader (300) if the information indicates that the electronic entity (100, 200) is in an orientation (α) not included in said set.

5. Electronic entity according to claim 4, characterized in that the means for preventing the exchange are capable of deactivating a module (130) for communication with the reader.

6. Electronic entity according to claim 4, characterized in that the means for preventing the exchange are capable of inhibiting the execution of an application causing the exchange of the data when it is executed by a processor (210) of the electronic entity (100, 200).

7. Electronic entity according to claim 4, characterized in that the means for preventing the exchange are capable of inhibiting the transmission of certain data.

8. Electronic entity according to claim 4, characterized in that the means for preventing the exchange are capable of terminating a communication between the entity (100, 200) and the reader (300) without executing data-exchange instructions.

9. Electronic entity according to claim 1, characterized in that it comprises a chip card (200), the chip card (200) including the position sensor (230).

10. Electronic entity according to claim 9, characterized by means for configuring the position of the card in the electronic entity.

11. Electronic entity according to claim 1, characterized in that the processing means are included in a card of a subscriber to a mobile telephone network complying with the ISO7816 standard.

12. Electronic entity according to claim 1, characterized in that the measured orientation (α) is an angular value relative to the vertical (ZZ′).

13. Method used by processing means of an electronic entity comprising a position sensor, characterized in that it comprises the following steps:
reception (E406) of a request from a reader;
reception (E408) of an item of information indicative of the orientation of the electronic entity measured by the sensor;
automatic transmission of data (E414) to the reader in response to the request provided that the item of information indicates that the electronic entity is in an orientation included in a predetermined set of orientations.

14. Electronic entity according to claim 2, characterized by means for preventing an exchange of information between the electronic entity (100, 200) and the reader (300) if the information indicates that the electronic entity (100, 200) is in an orientation (α) not included in said set.

15. Electronic entity according to claim 3, characterized by means for preventing an exchange of information between the electronic entity (100, 200) and the reader (300) if the information indicates that the electronic entity (100, 200) is in an orientation (α) not included in said set.
